(19) United States
(12) Patent Application Publication
(10) Pub. No.: US 2024/0319439 A1
(43) Pub. Date: Sep. 26, 2024

(54) PHOTONIC TOPOLOGICAL DUPLEXER BASED ON COUPLED TOPOLOGICAL WAVEGUIDES

(71) Applicant: ZHEJIANG UNIVERSITY, Hangzhou (CN)

(72) Inventors: Fei GAO, Hangzhou (CN); Xinrong XIE, Hangzhou (CN)

(21) Appl. No.: 18/674,962

(22) Filed: May 27, 2024

Related U.S. Application Data
(63) Continuation of application No. PCT/CN2023/080087, filed on Mar. 7, 2023.

(30) Foreign Application Priority Data
Mar. 10, 2022 (CN) 202210231737.9

(51) Int. Cl. G02B 6/122

(52) U.S. Cl. CPC G02B 6/1225

(57) ABSTRACT

The present application discloses a photonic topological duplexer that functions as a delay line and an absorber at different wavelengths based on coupled topological waveguides, comprising a silicon substrate; a plurality of cylindrical air holes distributed on the silicon substrate, and the cylindrical air holes comprising a first and a second cylindrical air hole; the first cylindrical air hole and the second cylindrical air hole form primitive cells arranged in a honeycomb lattice period to form a first valley photonic crystal, and the positions of different cylindrical air holes in the first valley photonic crystal are exchanged to form a second valley photonic crystal; a first topological waveguide and a second topological waveguide are formed between two regions of the first valley photonic crystal and the second valley photonic crystal; the first topological waveguide and the second topological waveguide form coupled topological waveguides with a certain coupling length.

### CROSS-REFERENCE TO RELATED APPLICATIONS

The present application is a continuation of International Application No. PCT/CN2023/080087, filed on Mar. 7, 2023, which claims priority to Chinese Application No. 202210231737.9, filed on Mar. 10, 2022, the contents of both of which are incorporated herein by reference in their entireties.

### TECHNICAL FIELD

The present application relates to the field of optical communication and, in particular, to a photonic topological duplexer based on coupled topological waveguides.

### BACKGROUND

Topological physics provide powerful tools for manipulating light and have been widely studied by researchers at home and abroad because of their broad application prospects. Topological physics originates from condensed matter physics, and then it was introduced into photonics and has ignited intensive attention on topological photonics. So far, researchers have realized topological photonic system based on the quantum Hall effect, quantum spin Hall effect, and quantum valley Hall effect. Topological phases are usually characterized by topological invariants. In photonic systems, topological invariants can be represented by Chern numbers. When two types of topological photonic crystals with different Chern numbers form an interface, due to the bulk-edge correspondence, there will emerge robust topological interface states that are immune to perturbations and fabrication imperfections. To date, topological photonics has achieved fruitful results in integrated photonics, optical communication, and other fields, and is expected to be applied to quantum computing.

At present, most of the research on topological interface states focuses on the application and popularization of robust transmission characteristics. Recently, intense studies have converged on the interplay between topology and non-Hermiticity/nonlinearity, aiming to enrich the manipulation methods of light with topological photonic crystals, but they inevitably increase the complexity of the system and the difficulty of preparation.

### SUMMARY

The present application overcomes the defects of the prior art, and provides a photonic topological duplexer based on coupled topological waveguides.

According to an embodiment of the present application, a photonic topological duplexer structure based on coupled topological waveguides is provided, which includes a silicon substrate, a silicon dioxide substrate, and a plurality of cylindrical air holes.

A plurality of cylindrical air holes are distributed on the silicon substrate, and the cylindrical air holes comprise a first cylindrical air hole and a second cylindrical air hole; the diameter of the first cylindrical air hole is larger than that of the second cylindrical air hole to break spatial inversion symmetry; the first cylindrical air hole and the second cylindrical air hole form primitive cells, which are periodically arranged in a honeycomb lattice to form a first valley photonic crystal (VPC1), and the positions of different cylindrical air holes in the first valley photonic crystal are exchanged to form a second valley photonic crystal (VPC2); a first topological waveguide (WG1) and a second topological waveguide (WG2) are formed between two regions of the first valley photonic crystal and the second valley photonic crystal, wherein the first topological waveguide is of straight type and the second topological waveguide is of triangular type; the first topological waveguide and the second topological waveguide form coupled topological waveguides (Coupled WG) with a certain coupling length.

Further, the silicon substrate has a refractive index of 3.47, and the cylindrical air holes have a refractive index of 1.

Further, a lattice constant of the honeycomb lattice is p=401 nm, the diameter of the first cylindrical air hole is d₁=174 nm, and a radius of the second cylindrical air hole is d₂=81 nm.

Further, a thickness of the silicon substrate is h=220 nm.

Compared with the prior art, the technical solution provided by the embodiment of the present application can include the following beneficial effects:
1. The present application provides a photonic topological duplexer based on coupled topological waveguides, which can solve the problems of increased difficulty in system implementation and complexity of topological properties compared with the present schemes of introducing nonlinearity and non-Hermitian property to enrich the manipulation of light with topological photonic crystals.
2. The band structure of the coupled topological waveguides with a certain coupling length in the present application respectively show bandgap and passband characteristics in different wavelength ranges, so that the present application can realize two functions of a delay line and an absorber at different wavelengths, respectively, and thus has a good application prospect.

It is to be understood that both the foregoing general description and the following detailed description are exemplary and explanatory only and are not intended to limit the present application.

### BRIEF DESCRIPTION OF DRAWINGS

The accompanying drawings, which are incorporated in and constitute a part of this specification, illustrate embodiments consistent with the present application and serve to explain the principles of the present application together with the description.

FIG. 1 is a schematic structural diagram of a photonic topological duplexer based on coupled topological waveguides according to an exemplary embodiment.

FIG. 2 is a structure diagram of edge state energy bands of a first topological waveguide, a second topological waveguide and coupled topological waveguides according to an exemplary embodiment.

FIG. 3 is a graph showing the structural transmittance according to an exemplary embodiment.

FIG. 4 is a power distribution diagram of the photonic topological duplexer corresponding to the two labeled points shown in FIG. 3.

### DESCRIPTION OF EMBODIMENTS

Reference will now be made in detail to exemplary embodiments, examples of which are illustrated in the accompanying drawings. When the following description refers to the drawings, unless otherwise indicated, the same numbers in different drawings indicate the same or similar elements. The embodiments described in the following exemplary embodiments do not represent all embodiments consistent with the present application. Rather, they are merely examples of devices and methods consistent with some aspects of the present application as detailed in the appended claims.

The terminology used in the present application is for the purpose of describing specific embodiments only and is not intended to limit the present application. The singular forms “a”, “said” and “the” used in the present application and the appended claims are also intended to include the plural forms, unless the context clearly indicates other meaning. It should also be understood that the term “and/or” as used herein refers to and includes any or all possible combinations of one or more associated listed items.

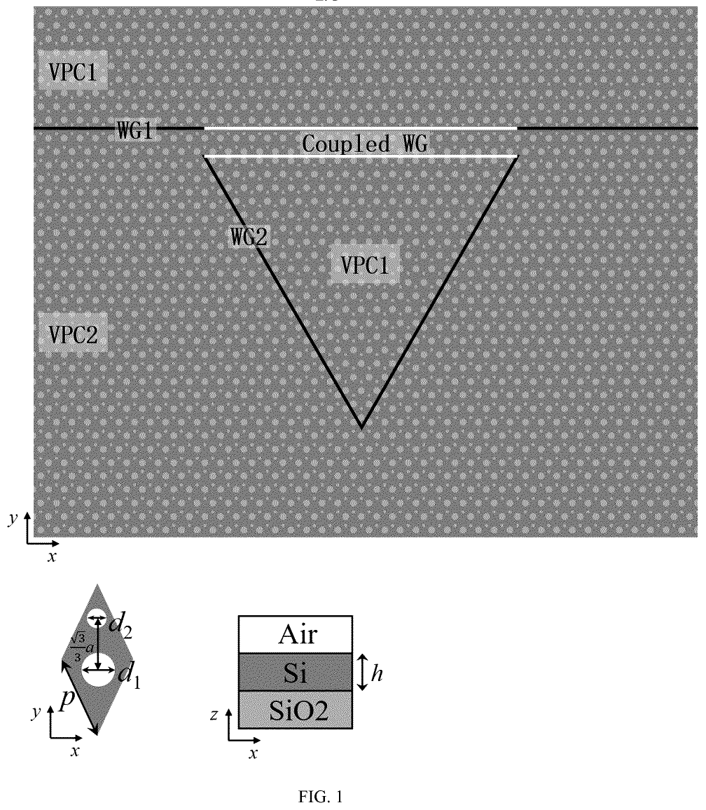

First, a photonic topological duplexer structure based on coupled topological waveguides according to an embodiment of the present application will be described in detail with reference to the attached drawings. As shown in FIG. 1, the structure includes a silicon substrate, a silicon dioxide substrate and a plurality of cylindrical air holes. The cylindrical air holes are arranged in the silicon substrate, and the cylindrical air holes comprise the first cylindrical air hole and the second cylindrical air hole. The diameter of the first cylindrical air hole is larger than that of the second cylindrical air hole to break the spatial inversion symmetry. The first cylindrical air hole and the second cylindrical air hole form primitive cells, which are periodically arranged in a honeycomb lattice and form a first valley photonic crystal (VPC1). The positions of different cylindrical air holes in the first valley photonic crystal are exchanged to form a second valley photonic crystal (VPC2). A first topological waveguide (WG1) and a second topological waveguide (WG2) are formed between the two regions of the first valley photonic crystal and the second valley photonic crystal, wherein the first topological waveguide is of straight type and the second topological waveguide is of triangular type. The first topological waveguide and the second topological waveguide form coupled topological waveguides (Coupled WG) with a certain coupling length.

Specifically, in this embodiment, the refractive index of the silicon substrate is 3.47, and the refractive index of the air hole is 1. The lattice constant of the honeycomb lattice is p=401 nm, the diameter of the first cylindrical air hole is d₁=174 nm, and the radius of the second cylindrical air hole is d₂=81 nm.

Specifically, in this example, the coupling length of the coupled topological waveguide is 20p=8.02 mm.

Specifically, in this example, the thickness of the silicon substrate is h=220 nm.

The photonic crystal structure in this embodiment is manufactured on a standard silicon-on-insulator wafer (SOI), and there is a silicon layer with a thickness of 220 nm thick on a buried oxide layer with a thickness of 2 mm. The topological photonic crystals structure is made by electron beam lithography, and then the pattern is transferred from the photoresist to silicon by reactive ion etching. Finally, the wafer is immersed in acetone for 30 minutes to remove the photoresist. In this way, a valley photonic topological duplexer can be obtained.

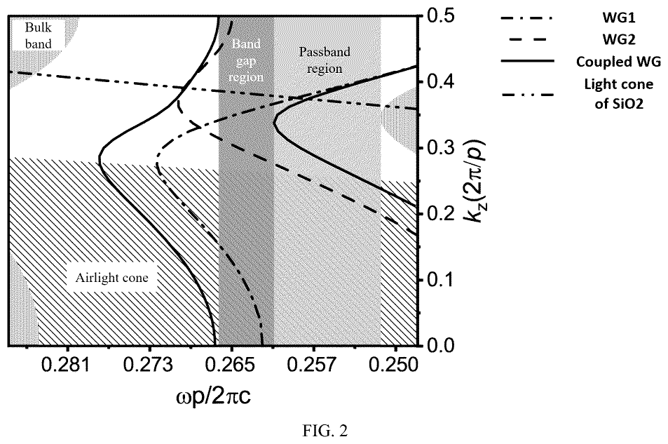

As shown in FIG. 2, it includes band diagrams of the first topological waveguide, the second topological waveguide, and the coupled topological waveguides in the embodiment of the present application, in which the vertical shaded area is the bulk band and the diagonal shaded area is the light cone of air. As can be seen from the figure, the phase velocities of the first topological waveguide and the second topological waveguide are positive, while the group velocities are negative/positive, showing the characteristics of backward/forward wave waveguides. For the dispersion curve of the coupled topological waveguides, it shows band gap characteristics in the wavelength range of 1492-1520 nm, and passband characteristics in the wavelength range of 1520-1593 nm.

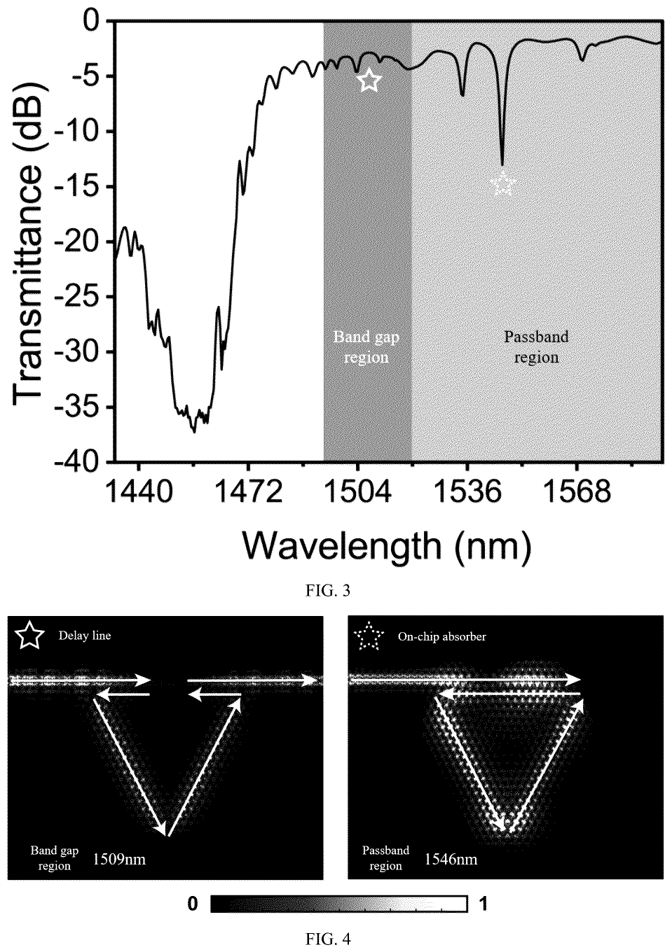

As shown in FIG. 3, it is the transmission curve of the photonic topology duplexer from the left port to the right port. As can be seen from the figure, it shows high transmission characteristics in the band gap range of 1492-1520 nm. However, in the passband range of 1520-1593 nm, it shows low transmission rate characteristics.

As shown in FIG. 4, the power distribution diagrams of a TM-mode light transmission with wavelengths of 1509 nm and 1546 nm corresponding to the two labeling symbols in FIG. 3, respectively. 1509 nm is in the band gap region. The injected light from the left end of WG1 is reflected by the coupled topological waveguides into the uncoupled region of WG2, re-entered the coupling region, reflected into WG1, and finally output from the right end of WG1, showing the function of a delay line. While 1546 nm is in the passband region. The light is input from the left end of WG1, but not output from the right end of WG1. The light is consumed internally, showing the characteristics of an on-chip absorber. Therefore, this structure realizes the function of a duplexer.

The photonic topological duplexer structure designed by the present application realizes the functions of a delay line and an absorber at different wavelengths in the wave band around 1520 nm, and shows the characteristics of a duplexer.

Those skilled in the art can easily envisage of variations or substitutions after considering the specification and practicing the contents disclosed herein, and come up with other embodiments of the present application. The present application is intended to cover any variation, use or adaptation of the present application, which follows the general principles of the present application and includes common knowledge or common technical means in the technical field that are not disclosed in the present application. The specification and examples are to be regarded as exemplary only, with the true scope and spirit of the present application being indicated by the following claims.

It shall be appreciated that the present application is not limited to the precise structure described above and shown in the drawings, and various modifications and changes can be made without departing from its scope. The scope of the present application is limited only by the appended claims.

What is claimed is:

1. A photonic topological duplexer based on coupled topological waveguides, comprising:
a silicon substrate;
wherein a plurality of cylindrical air holes are distributed on the silicon substrate, and the cylindrical air holes comprise a first cylindrical air hole and a second cylindrical air hole; a diameter of the first cylindrical air hole is larger than a diameter of the second cylindrical air hole to break spatial inversion symmetry; the first cylindrical air hole and the second cylindrical air hole constitute primitive cells, the primitive cells are periodically arranged in a honeycomb lattice to form a first valley photonic crystal (VPC1), and positions of different cylindrical air holes in the first valley photonic crystal are exchanged to form a second valley photonic crystal (VPC2); a first topological waveguide (WG1) and a second topological waveguide (WG2) are formed between two regions of the first valley photonic crystal and the second valley photonic crystal, wherein the first topological waveguide is of straight type, and the second topological waveguide is of triangular type; the first topological waveguide and the second topological waveguide form coupled topological waveguides (Coupled WG); a left boundary and a right boundary of the second topological waveguide have no coupling relationship with the first topological waveguide.

2. The photonic topological duplexer based on coupled topological waveguides according to claim 1, wherein the silicon substrate has a refractive index of 3.47, and the cylindrical air holes have a refractive index of 1.

3. The photonic topological duplexer based on coupled topological waveguides according to claim 1, wherein a lattice constant of the honeycomb lattice is p=401 nm, the diameter of the first cylindrical air hole is d₁=174 nm, and a radius of the second cylindrical air hole is d₂-81 nm.

4. The photonic topological duplexer based on coupled topological waveguides according to claim 1, wherein a thickness of the silicon substrate is h=220 nm.
